(19) United States
(12) Patent Application Publication
(10) Pub. No.: US 2005/0219622 A1
(43) Pub. Date: Oct. 6, 2005

(54) Method for adjusting halftone image size

(76) Inventors: Chen-Chung Chen, Yang-Mei (TW); Cheng-Huei Chiang, Lung-Ching (TW)

Correspondence Address: RABIN & CHAMPAGNE, P.C., Suite 500, 1101 14 Street, N.W., Washington, DC, 20005, US

(21) Appl. No.: 10/704,636

(22) Filed: Nov. 12, 2003

(51) Int. Cl. H04N 1/52

(52) U.S. Cl. 358/3.06; 358/534

(57) ABSTRACT

A method for adjusting the size of a halftone image is first to process the original image into a halftone image. Then, calculating weighting values for each pixel by the weight allocation windows. Finally, weighting each pixel by the weighting values through error diffusion operation to get the final size halftone image.

### BACKGROUND OF THE INVENTION

1. Field of the Invention

The invention generally relates to a method for adjusting an image size, and in particular relates to a method for adjusting the size of a halftone image.

2. Related Art

As new technologies being developed, digital cameras are taking places of conventional cameras and becoming a major tool of photography. The image files in the digital camera after picture-taking can be transferred to a computer and outputted through a printer or a multi-function peripheral. The size of the image output can be enlarged or reduced according to user's needs. Therefore, the image output method through printer or multi-function peripheral is much more convenient than that of conventional photochemical process through films and photos.

Please refer to FIG. 1, a conventional process of adjusting an image size in a printer or a multi-function peripheral includes the following steps.

First, in step 11, the image data is copied or scanned into three origin color data, red, green and blue (RGB) images. Supposing the image size is n*m. Then, in step 12, the RGB images size is adjusted into new RGB image size N*M. In step 13 and 14, the RGB image is transformed into four printing color, C(cyan), M(magenta), Y(yellow) and K(key, black) images. Further, in step 15 and 16, the four-color CMYK images are processed with halftoning and made into N*M halftone images. Finally, in step 17, the halftone images are processed and printed out through a printer or a multi-function peripheral.

In the aforesaid image transformation process, the final image size is transformed at the beginning. That is, the RGB image is first size transformed, then CMYK transformed, and halftoning, etc.

When the image size is enlarged, each pixel in the enlarged image has to be CMYK transformed, and halftoning. The time required for these processes is much more than that of the original image. Therefore, when an image is enlarged twice, the total processing time for color transformation and halftoning is about three times of that of original image. The more the image being enlarged, the longer time the image processes require.

### SUMMARY OF THE INVENTION

The object of the invention is to provide a method for adjusting the size of a halftone image. The original RGB image is first processed into halftone image. Then, calculating a weighting value for each pixel through some weight allocation windows. Finally, weighting calculation for each pixel by the weighting values and an error diffusion operation to get the final size halftone image.

The transformation method according to the invention effectively saves the processing time required for conventional image size transformation where the image is first enlarged before CMYK color transformation and halftoning.

As shown in FIG. 2, a process of the invention, comparative to the process of prior arts of FIG. 1, includes steps 21 to 25 that are similar to processes of conventional printers or multi-function peripheral. In steps 21 and 22, the original RGB color data of image size n*m is transformed into CYMK image data of the same size. Then, in step 24, halftoning the CYMK image data into halftone image of size (pixels) n*m (step 25).

Then, in step 26, transforming a weight allocation window with a predetermined size, and calculating the weighting value of the halftone image. This step is to calculate weighting values of every dot of the halftone image through a weight allocation window. The image size is now enlarged to N*M. The areas which the weight allocation windows being covered are corresponding to black pixels of the original halftone image. In step 27, applying error diffusion operation to the pixels to get the enlarged halftone image. And finally, in step 28, the halftone image is outputted through a printer or a multi-function peripheral.

In the aforesaid steps, the size of a weight allocation window is determined by an enlargement ratio of the final image size to the original image. And, the discreteness of pixels is therefore influenced.

In order to prevent the enlarged image from zigzag roughness, the invention applies error diffusion operation for the half tone image enlargement. Each pixel is calculated through weighting values. Appling error filters to average the weighting values of adjacent pixels of the enlarged image, and comparing it with original image and getting a quantization error value. Applying the quantization error to the next pixel by subtracting the deviation value from the weighting value of the correspondent original pixel so as to increase or decrease the weighting value of the next pixel. Afterwards, the weighting and error diffusion for the pixels make the final image smoother.

### BRIEF DESCRIPTION OF THE DRAWINGS

The invention will become more fully understood from the detailed description given herein below. However, this description is for purposes of illustration only, and thus is not limitative of the invention, wherein:

FIG. 1 is a flowchart of prior arts showing the image size transformation process in a conventional printer or multi-function peripheral;

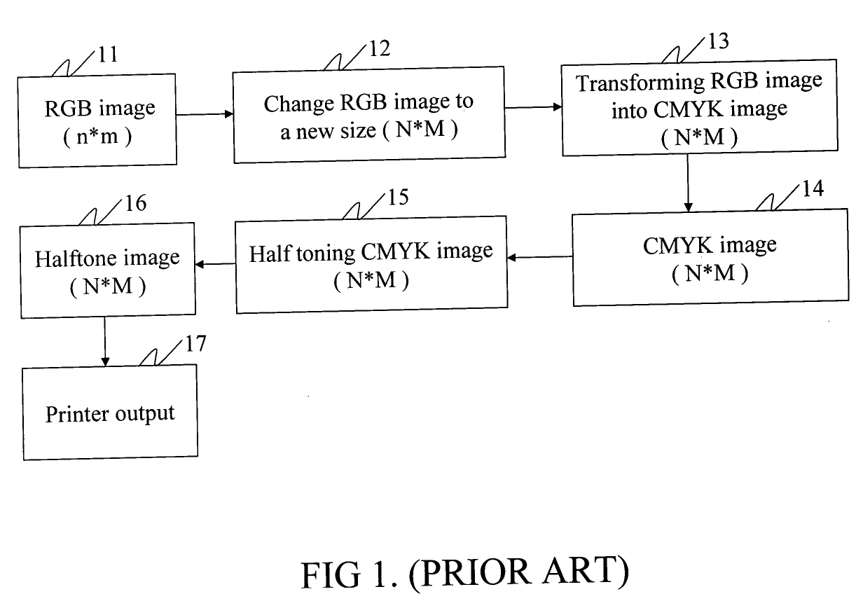

FIG. 2 is a flowchart of a halftone image size transformation process of the invention;

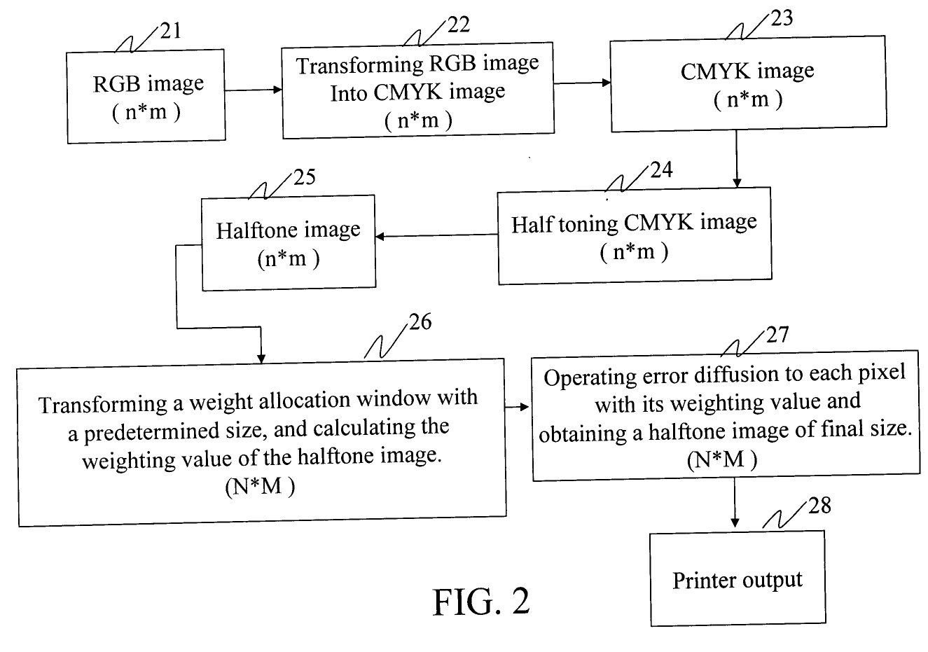

FIG. 3 is a primary flowchart of process of the invention;

FIG. 4 is a descriptive example of an original halftone image to be processed by the invention;

FIG. 5 is a result of weight values generated from image of FIG. 4 and applied to a weight allocation window;

FIG. 6 is a principle diagram of error diffusion operation in the invention;

FIG. 7 is a serpentine operational sequence diagram of error diffusion to the pixels;

FIG. 8 is a calculated result of the pixels after error diffusion operation; and

FIG. 9 is the finished halftone image enlarged from original image of FIG. 4 and through process of the invention.

### DETAILED DESCRIPTION OF THE INVENTION

The halftone image size transformation method of the invention is applicable to image output devices, such as multiple-function peripherals, scanners or printers, for adjusting the image size. The original RGB image color data are transformed into CMYK data and halftone images. Then, calculating weighting values of each pixel of the size-transformed image in a weight allocation window; and operating error diffusion to the pixels to get the final halftone image. The method saves the total process time of image transformation.

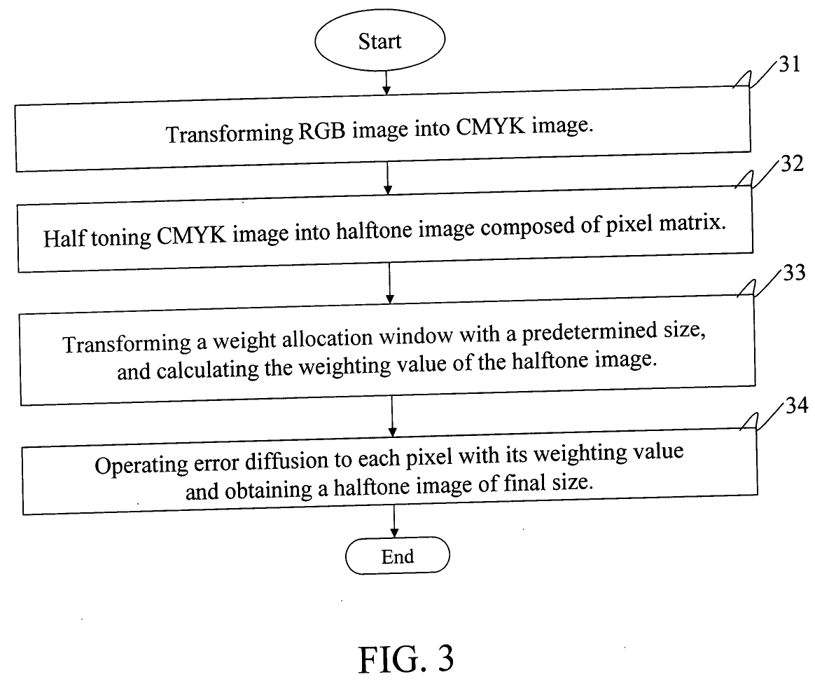

The primary flowchart of process of the invention is shown in FIG. 3. The RGB image data are first transformed into CMYK image data (step 31). A color image on computer is usually processed in RGB data mode. However, they have to be transformed into CMYK mode when being outputted for printing in order to meet the ink color system.

Therefore, the original RGB image is first obtained by copying or scanning. Then, the RGB data are transformed into CMYK data through color mode transformation.

The CMYK data are further processed into halftone data composed of a matrix of pixels through a halftoning process (step 32). Halftone is a binary image transformed from continuous grayscale. The binary (black and white) pattern matrix gives human eyes a vision similar to the original grayscale.

Halftoning is to transform image grayscale into black pixel patterns of different intensity or distribution so that, through optical illusion of human eyes, the grayscale is viewed. The CMYK image data obtained in step 31 are processed through halftoning into halftone images.

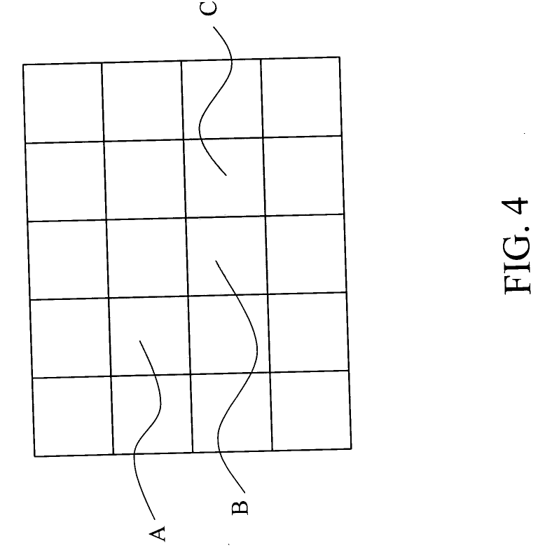

As shown in FIG. 4, a descriptive example of a halftone image includes three black pixels A, B and C generated through halftoning. This example will be used for descriptive examples of further process in the invention hereinafter.

In step 33, transforming a weight allocation window with a predetermined size, and calculating the weighting values of the halftone image. Calculating weighting value of every dot of the halftone image through a weight allocation window, and the areas which the weight allocation windows being covered are corresponding to black pixels of the original halftone image.

Firstly, the weight allocation window is determined by an original predefined window size and an enlargement ratio. For example, the original window size is specified as 3*3 pixels; the enlargement ratio is 2, then the weight allocation window is 6*6 pixels.

Then, summarizing the weighting values of every pixel according to the covering frequency of the weight allocation window.

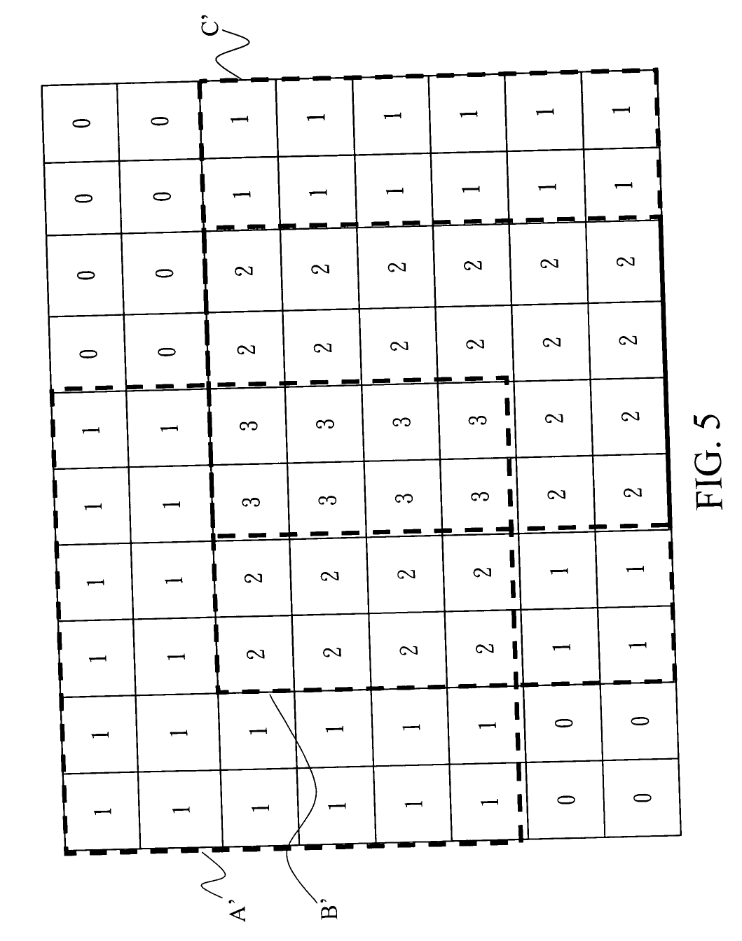

FIG. 5 is a result of weighting after calculation of the weighting values in the pixel matrix enlarged from the halftone image of FIG. 4. The weighting for each pixel is calculated as follows.

The weight allocation windows in dotted squares A′, B′, C′ are correspondent to the locations of black pixels A, B, C in the halftone image. Each pixel in each weight allocation window is defined with a value “1”. Any pixels covered by two overlapped windows are summed as “2” (1+1=2). Any pixel covered by three overlapped windows are summed as “3” (1+1+1=3), and so on.

Further, in step 34, operating error diffusion to each pixel with its weighting value and obtaining a halftone image of final size. The error diffusion operation is to consider the adjacent pixel by applying a quantization error calculated from the adjacent pixel, and comparing through a threshold value. The halftone image processed by error diffusion is moved to a higher frequency spectrum that is better for human vision as a smoother continuous tone image.

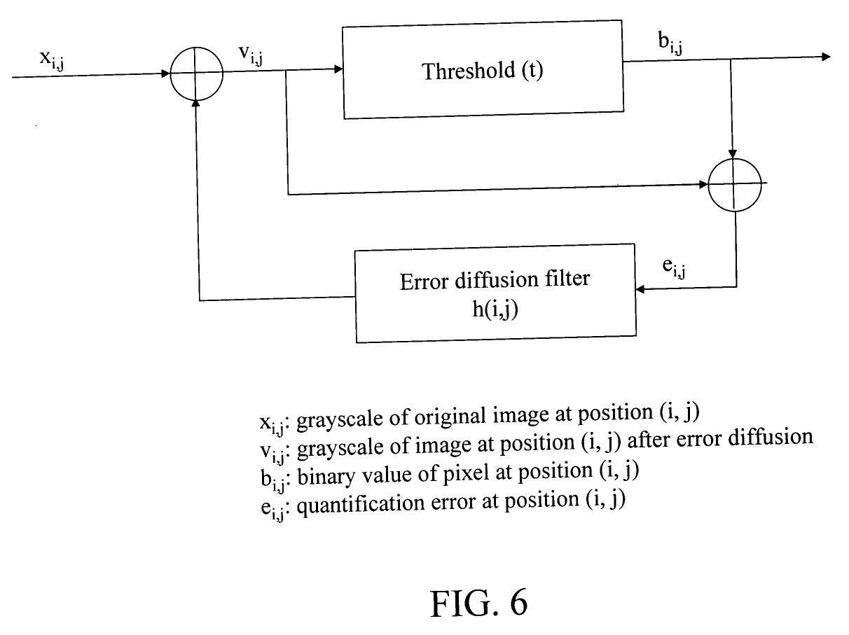

FIG. 6 illustrates the principle of error diffusion operation in the invention. The meanings of the parameters or designations in the diagram are as follows.

x_{i,j}: the grayscale of original image at position (i, j);

b_{i,j}: the binary value of pixel at position (i, j);

v_{i,j}: the grayscale of image at position (i, j) after error diffusion;

t: threshold;

e_{i,j}: the quantization error at position (i, j); and

h (i,j): error diffusion filter.

The binary value b_{i,j} is obtained by comparing the grayscale v_{i,j} with the threshold t. When v_{i,j} is larger than t, then b_{i,j}=1. Otherwise, when v_{i,j} is equal to or less than t, then b_{i,j}=0.

e_{i,j} is the quantization error between binary value b_{i,j} and the grayscale v_{i,j}. The quantization error e_{i,j} passing through the error diffusion filter h(i,j) provides a feedback to the next pixel. The error diffusion filter h (i,j) applies the quantization error of adjacent pixels for averaging and weighting. If the output of the error diffusion filter h (i,j) is larger than zero, then the average grayscale of adjacent area of the current pixel is too bright than the original image. Otherwise, it is too dark.

In order to compensate the deviation of image, the quantization error is applied to the next pixel by subtracting the error value from the grayscale value of the next pixel so as to change it darker or lighter before quantization. Therefore, the final grayscale of the binary image b_{i,j} output is similar to the grayscale of original image x_{i,j}. The aforesaid process can be presented with the following equations:

$$\begin{matrix}{v}_{i , j} = {x}_{i , j} - {\sum }_{m , n} {h}_{m , n} {e}_{i - m , j - n} \\ {b}_{i , j} = \{ \begin{matrix}1 & if {v}_{i , j} > t \\ 0 & otherwise\end{matrix} \\ {e}_{i , j} = {b}_{i , j} - {v}_{i , j}\end{matrix}$$

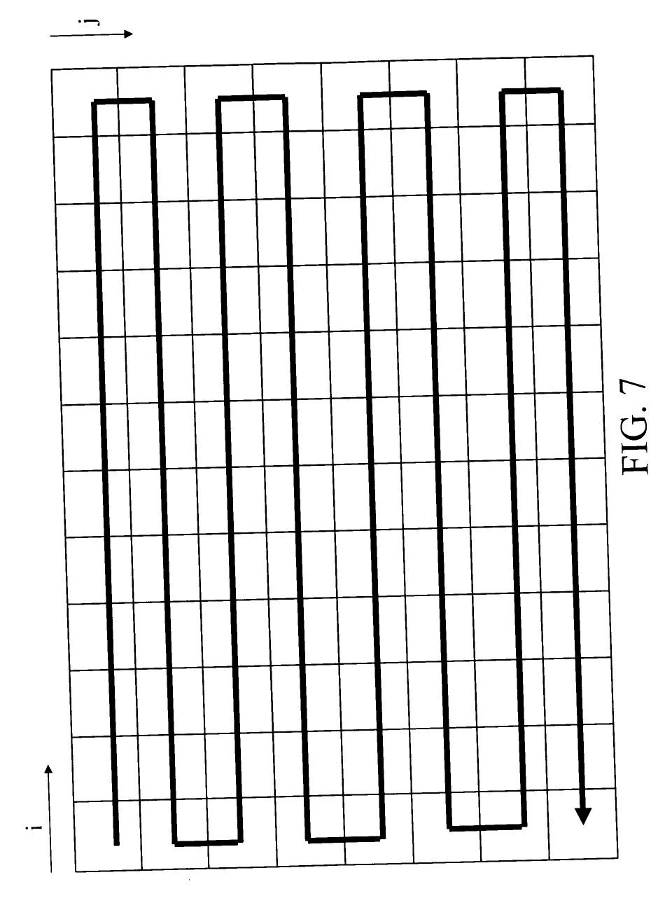

FIG. 7 illustrates an operational sequence of error diffusion to the pixels. It moves back and forth between the left and the right, and from the top to the bottom. The sequence is just of an example for a faster operation. The user can choose other sequences.

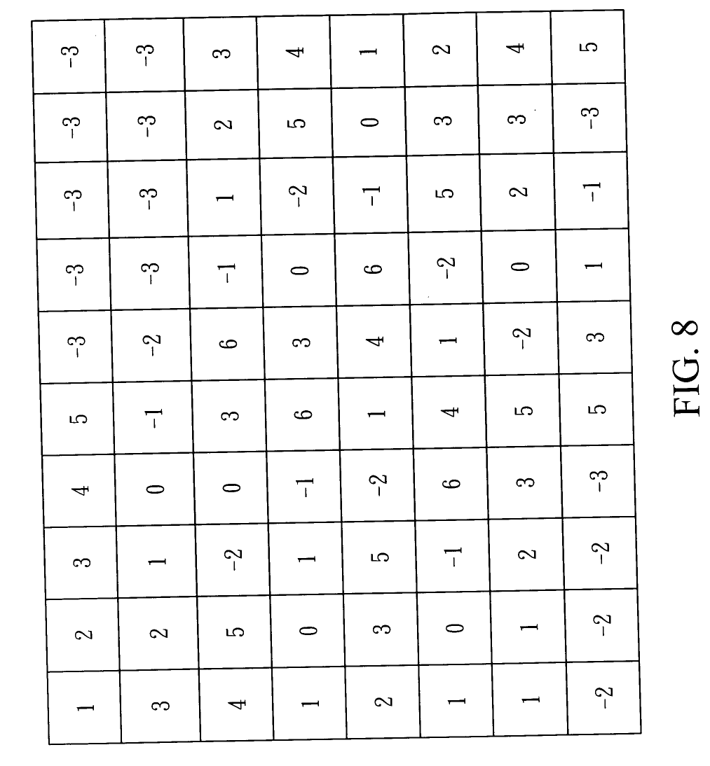

FIG. 8 is a calculated example result of the pixels after error diffusion operation. The operations of error diffusion in this example are described below.

First, setting the threshold t as a half of the maximum possible summation of the weight allocation windows, here is t=4.5 (half of 9). The weighted value of each pixel is the value of the pixel afore plus the value itself (see FIG. 5, by summation of the weight allocation windows). Taking the left second pixel of the first line as an example, the weighted value is 2 (the value 1 of the pixel afore plus the value 1 itself), which is smaller than the threshold t(4.5), therefore, the binary value b_{i,j} (b_{2,1}) is 0 (no output). Again, for the third pixel of the first line, the weighted value is 3 (the value 2 of the pixel afore plus the value 1 itself), which is smaller than the threshold t (4.5), therefore, the binary value bi,j (b_{3,1}) is 0 (no output). Then, for the fifth pixel of the first line, the weighted value is 5 (the value 4 of the pixel afore plus the value 1 itself), which is larger than the threshold t(4.5), therefore, the binary value b_{i,j} (b_{5,1}) is 1 (with output). Further, for the sixth pixel of the first line, the weighted value is −3 (the value 5 of the pixel afore plus the value 1 itself, and subtracted with the error value 9 diffused from the pixel afore), which is smaller than the threshold t(4.5), therefore, the binary value b_{i,j} (b_{6,1}) is 0 (no output); and so on.

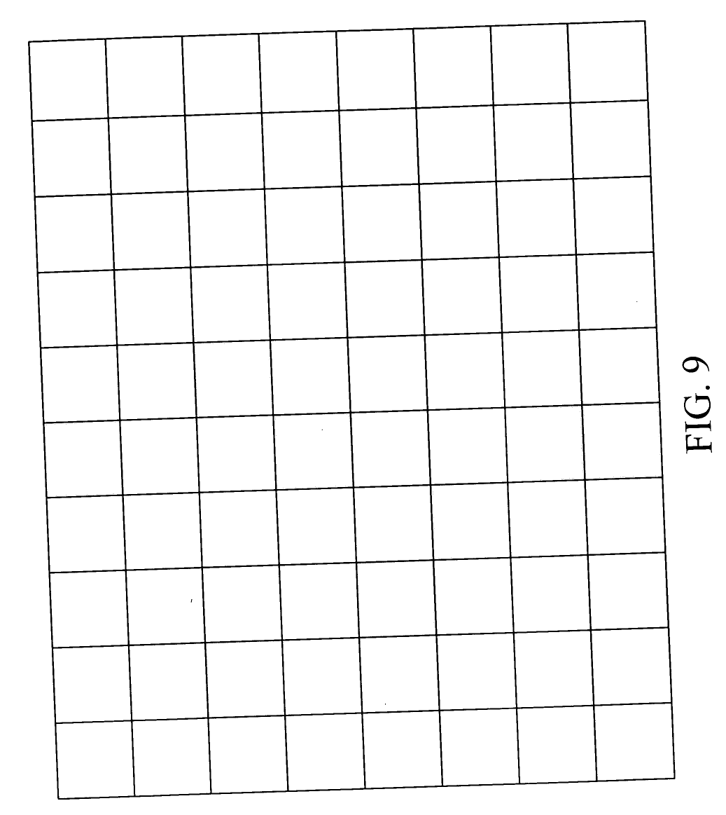

FIG. 9 is the finished halftone image enlarged from original image and through process of the invention. We can see that the image size transformation is not just simply enlarged from the original halftone image. The invention incorporates weight allocation windows and error diffusion operations for deciding the binary output. The enlarged image is therefore much similar to the original image and much smoother.

The aforesaid process is described for size change of a general RGB color image in printing. Of course, it can be directly applied to a halftone image. For a halftone image size transformation, first weighting each pixel of the enlarged image through weight allocation windows. Then, operating error diffusion to each pixel to get the finished halftone image.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method for adjusting a halftone image size, comprising steps of:
transforming an original image into a halftone image of original size, said halftone image is composed of a plurality of pixels;
transforming a weight allocation window with a predetermined size, and calculating the weighting value of the pixels of said halftone image; and
operating a further weighting to each pixel in said weight allocation window and obtaining a halftone image of final size.

2. The method for adjusting a halftone image size according to claim 1 wherein said original image is a RGB color image to be first transformed into CMYK data for further halftone process.

3. The method for adjusting a halftone image size according to claim 1 wherein said original image is a CMYK image for further halftone process.

4. The method for adjusting a halftone image size according to claim 1 wherein said step of weighting each pixel in said weight allocation window is to allocate weighting windows correspondent to positions of black pixels in said original halftone image.

5. The method for adjusting a halftone image size according to claim 1 wherein size of said weight allocation window is determined by an original predefined window size and an enlargement ratio.

6. The method for adjusting a halftone image size according to claim 1 wherein said step of weighting each pixel in said weight allocation window is to get a summation of times of weight allocation windows that cover said pixel.

7. The method for adjusting a halftone image size according to claim 1 wherein said step of operating a further weighting to each pixel in said weight allocation window is to apply error diffusion.
